(19) United States
(12) Patent Application Publication
(10) Pub. No.: US 2024/0308142 A1
(43) Pub. Date: Sep. 19, 2024

(54) SYSTEMS AND METHODS FOR 3D PRINTING

(71) Applicant: METAFOLD INC., Toronto (CA)

(72) Inventors: Daniel HAMBLETON, Toronto (CA); Tomasz T. RESLINSKI, Toronto (CA); Elissa ROSS, Toronto (CA)

(21) Appl. No.: 18/546,702

(22) PCT Filed: Feb. 17, 2021
(86) PCT No.: PCT/CA2021/050171

§ 371 Date: Aug. 16, 2023

(51) Int. Cl. B29C 64/393; B29C 64/129; B29C 64/232; B29C 64/236; B29C 64/241; B29C 64/264; B33Y 10/00; B33Y 30/00; B33Y 50/02

(52) U.S. Cl. CPC B29C 64/393; B29C 64/129; B29C 64/236; B29C 64/241; B29C 64/264; B33Y 10/00; B33Y 30/00; B33Y 50/02; B29C 64/232

(57) ABSTRACT

There is provided a three-dimensional (3D) printing system for printing a part with complex geometry. The 3D printing system comprises a first motor operatively coupled to a linear actuator for moving a build plate, the first motor configured to report a first physical state of the first motor in real time. The 3D printing system also includes a processor coupled to the first motor for receiving the first physical state as part of a hardware state of the system, receiving mathematical representations of elements of the part with complex geometry, and evaluating the mathematical representations in functions with the hardware state to render an image of at least a portion of a slice of the part. A projector is included for projecting the image onto resin, wherein light from the image cures a portion of the resin to form at least the portion of the slice of the part.

### FIELD

The present disclosure is related to systems and methods for three-dimensional (3D) printing, and in particular, for 3D printing of parts with complex geometries. The disclosure also relates to monitoring systems and methods for improving performance of 3D printers.

### BACKGROUND

3D printing has allowed for the creation of geometrical products that are often difficult to produce with traditional manufacturing methods. Traditionally, 3D printing requires the surface of the 3D print geometry or object to be encoded in a mesh file format such as STL, OBJ, or 3MF. In some 3D printers, these mesh files are then sliced into two-dimensional images that are sent to the 3D printer to be printed as consecutive layers. In order to represent complex geometry, the number of triangles needed to smoothly approximate the surface becomes extremely large, if not prohibitively so. This results in enormous files, which may be impractical.

As well, the slicing procedure may become prohibitively slow as the geometry becomes more and more complex. Thus, complex but repetitive geometries (such as lattices, microstructures, and metamaterials) are not well-represented by a triangle mesh. The STL files for such complex geometries become prohibitively difficult and time consuming to produce given the required size of the file to accurately represent the geometry (e.g., in computer memory or on disk), and given the challenges of processing the data in that representation (e.g., requiring excessive computation time or a large amount of computing power). These challenges are compounded further if large build volumes with the complex geometries are desired.

Another challenge with traditional 3D printing is the requirement of a watertight mesh as an input. Although there exists various software programs that offer repair and correction of problematic mesh geometry, there are some meshes that are so damaged (e.g. by having holes, cracks or degenerate triangles) that they simply cannot efficiently be made watertight and, therefore, cannot be 3D printed. Such damaged meshes could be repaired manually, however, such repair would require many hours of human processing before they can be made acceptable for printing.

Thus, there remains a need to provide systems and methods for improving the performance of 3D printing when printing parts with complex geometries, especially in larger build volumes.

### SUMMARY

The present disclosure provides a three-dimensional (3D) printing system configured to print a part with complex geometry, the 3D printing system comprising: a first motor operatively coupled to a linear actuator for moving a build plate, the first motor configured to report a first physical state of the first motor in real time during a printing process, the first physical state comprising metrics of the first motor; a processor coupled to the first motor, the processor configured to: receive the first physical state from the first motor, the first physical state forming part of a hardware state of the system; receive one or more geometric primitives, the one or more geometric primitives being respective mathematical representations of respective elements of the part with the complex geometry; and input the hardware state and the one or more geometric primitives into one or more functions to evaluate points on an image plane of a projector and render an image of at least a portion of a slice of the part; and the projector coupled to the processor for projecting the image onto resin; wherein light from the projected image cures a portion of the resin to form at least the portion of the slice of the part with complex geometry on the build plate.

In some examples, the present disclosure provides a method of three-dimensional (3D) printing of a part having complex geometry with a 3D printing system, the method comprising: retrieving a first physical state of a first motor, the first physical state comprising metrics of the first motor and forming part of a hardware state of the 3D printing system; retrieving one or more geometric primitives, the one or more geometric primitives being respective mathematical representations of respective elements of the part with complex geometry; input the hardware state and the one or more geometric primitives into one or more functions to evaluate points on an image plane of a projector and generate an image of at least a portion of a slice of the part; and projecting the image onto resin, wherein light from the image cures a portion of the resin to form at least the portion of the slice of the part.

In some examples, the present disclosure provides a torque monitoring system for use in a three-dimensional (3D) printing system when printing a part, the 3D printing system comprising a resin container with a bottom of release film, a linear actuator assembly having a vertical shaft extending away from the resin container, a build plate slidably secured to the vertical shaft above the resin container for holding the part, and a projector situated below, and directed towards, the resin container, the monitoring system comprising: a first motor operatively coupled to the linear actuator for moving the build plate up and down along the vertical shaft, the first motor configured to report torque in real-time during a printing process; a processor coupled to the motor, the processor configured to: monitor torque of the first motor in real-time; identify a predetermined torque metric during the printing process; and instruct the motor to stop moving the build plate in response to the identified predetermined torque metric.

A method of monitoring a printing process of a three-dimensional (3D) printing system for printing a part, the 3D printing system comprising a resin container with a bottom of release film, a linear actuator assembly having a vertical shaft extending away from the resin container, a build plate slidably secured to the vertical shaft above the resin container for holding the part, and a projector situated below, and directed towards, the resin container, a first motor operatively coupled to the linear actuator assembly for moving the build plate up and down along the vertical shaft, and a projector directed towards and situated below the resin container, the method comprising: monitoring torque of the first motor in real time; identifying a predetermined torque metric during the printing process; and stopping movement of the build plate in response to the identified predetermined torque metric.

In some examples, the present disclosure provides a resin monitoring system for use in a three-dimensional (3D) printing system when printing a part, the 3D printing system comprising a resin container with a bottom of release film, the resin container adapted to hold resin forming a resin surface; a linear actuator assembly having a vertical shaft extending away from the resin container, a build plate slidably secured to the vertical shaft above the resin container for holding the part, the resin monitoring system comprising: a laser source positioned above the resin container and orientated to direct a laser beam onto the resin surface, the resin surface reflecting the laser beam to a reflected laser point an external surface; and a visual sensor adapted to identify a position of the reflected laser point on the external surface; wherein the position of the reflected laser point on the external surface indicates a level of resin in the resin container; and wherein change in the level of resin in the resin container changes the position of the reflected laser point on the external surface.

A method of monitoring a printing process of a three-dimensional (3D) printing system for printing a part, the 3D printing system comprising a resin container with a bottom of release film, the resin container adapted to hold resin forming a resin surface, a linear actuator assembly having a vertical shaft extending away from the resin container, a build plate slidably secured to the vertical shaft above the resin container for holding the part, the method comprising: directing a laser beam onto the resin surface, the resin surface reflecting the laser beam onto an external surface as a reflected laser point; and identifying a position of the reflected laser point on the external surface with a visual sensor; wherein the position of the reflected laser point on the external surface indicates a level of resin in the resin container; and wherein change in the level of resin in the resin container changes the position of the of the reflected laser point on the external surface.

The foregoing and other aspects and advantages of the present disclosure will appear from the following description. In the description, reference is made to the accompanying drawings that form a part hereof, and in which there is shown by way of illustration a preferred embodiment. Such embodiment does not necessarily represent the full scope of the disclosure, however, and reference is made therefore to the claims and herein for interpreting the scope of the disclosure.

### BRIEF DESCRIPTION OF THE DRAWINGS

Reference will now be made, by way of example, to the accompanying drawings which show example embodiments of the present application, and in which:

FIG. 1 is a block diagram of a three-dimensional (3D) printing system with a torque monitoring system in accordance with example embodiments of the present disclosure;

FIG. 2 is a perspective view of a printer assembly of the 3D printing system of FIG. 1.

FIG. 3 is an exploded view of the printer assembly of FIG. 2.

FIG. 4 is a flowchart setting forth the steps of an example method for printing a part with complex geometries using the 3D printing system of FIG. 1;

FIG. 5a is a perspective view of the projector and resin container of FIG. 2 in isolation;

FIGS. 5b, 5c, and 5d are perspective views of alternate embodiments of the projector and resin container of FIG. 5a;

FIG. 6 is a diagram illustrating fixed projection using the projector and resin container of FIG. 5a;

FIG. 7 is a diagram illustrating single mobile axis projection using the projector and resin container of FIG. 5b;

FIG. 8 is a diagram illustrating dual mobile axis projection using the projector and resin container of FIG. 5d;

FIG. 9 is a perspective view of a resin monitoring system in accordance with an example embodiment of the present disclosure; and

FIG. 10 is a cross-sectional view of an alternate resin monitoring system in accordance with another example embodiment of the present disclosure.

### DETAILED DESCRIPTION

Described herein are systems, assemblies, and methods for three-dimensionally printing a part with complex geometry (or complex geometries) using a 3D printing system, and systems and methods for monitoring and improving a 3D printing process.

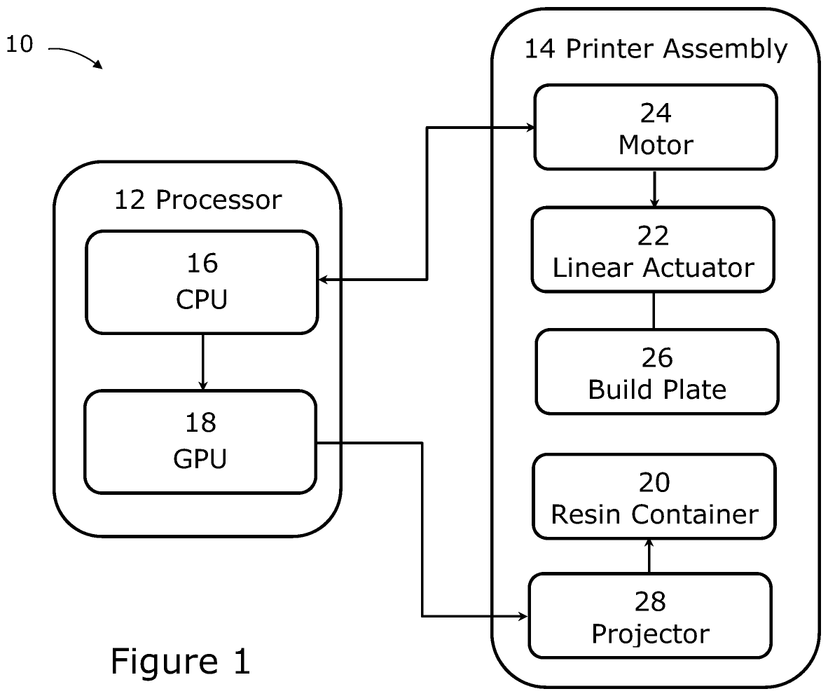

Referring to FIG. 1, a block diagram is shown of an example 3D printing system 10 for printing a part with complex geometry (or complex geometries) in accordance with an example embodiment. This implementation of 3D printing system 10 is for illustrative purposes only, and variations including additional, fewer and/or varied components are possible.

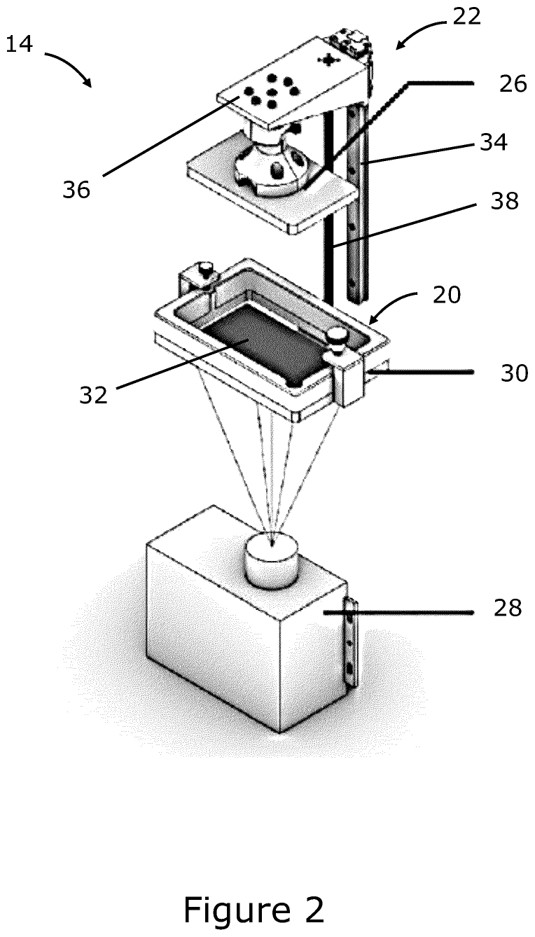

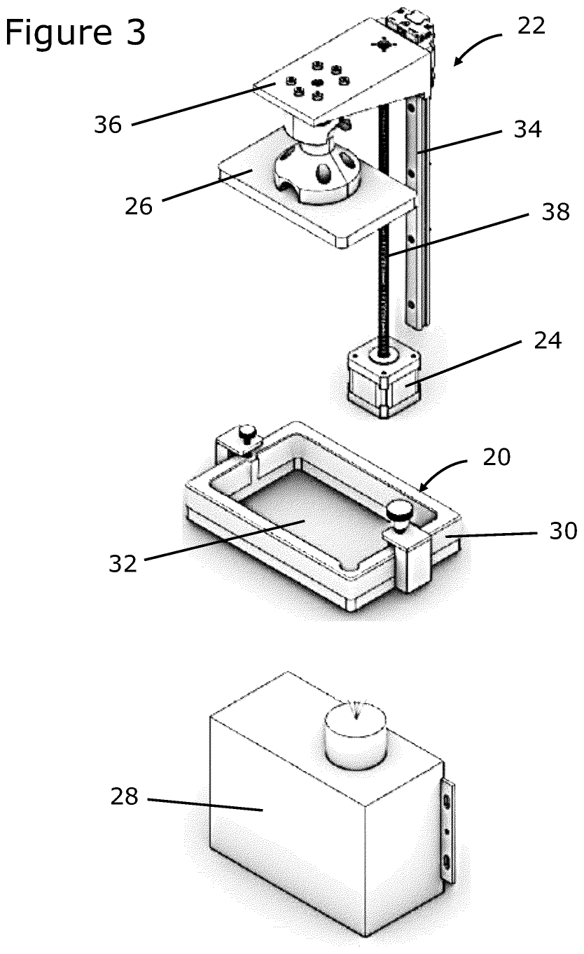

In the embodiment depicted in FIGS. 1-3, 3D printing system 10 comprises a processor 12 and a printer assembly 14 coupled to processor 12. Processor 12 includes a central processing unit (CPU) 16 and a graphics processing unit (GPU) 18. Printer assembly 14 includes a resin container 20, a linear actuator 22 extending from (and proximate to) resin container 20, a first motor 24 operatively coupled to linear actuator 20 and coupled to CPU 16, a build plate 26 secured to linear actuator 20 and positioned above and generally parallel to resin container 20, and a projector 28 coupled to GPU 18 positioned below resin container 20.

Turning first to printer assembly 14, resin container 20 has container walls 30, a base 32 of clear release film, and is adapted to hold resin, particularly photosensitive resin, therein. Linear actuator 22 comprises a vertical shaft 34, a plate holder 36 slidably coupled to vertical shaft 34, a lead screw 38 operatively coupled to plate holder 36 for moving plate holder 36 along a linear axis of vertical shaft 34. Vertical shaft 34 extends generally perpendicular from resin container 20, and may be secured to resin container 20.

First motor 24 in the present embodiment is a servo motor, which may be a stepper or DC motor, operatively coupled to lead screw 38 for actuating lead screw 38, which in turn moves plate holder 36 along the linear axis of vertical shaft 34. Build plate 26 is releasably secured to plate holder 36, and suspended over resin container 20. In this manner, first motor 24 controls the position of build plate 26 relative to resin container 20, and build plate 26 is adapted to hold the printed part as it is being printed and cured within resin container 20.

In the present embodiment, printer assembly 14 includes lead screw 38. However, in alternate applications, printer assembly 14 may instead comprise a different linear motion system, such as a ball-screw, a rack and pinion, or a belt driven axes, etc.

First motor 24 has firmware and electronic feedback that allows for direct querying by processor 12 of a variety of motor metrics related to motor operation, which is referred to herein as a first physical state of first motor 24. First motor 24 may be operated in one of a variety of modes to generate metric output data, including torque of first motor 24. In one operating mode, a PWM (pulse width modulated) signal that is proportional to the motor torque is outputted from the motor's IO port. In an alternative operating mode, the firmware sends the motor torque, along with other motor metrics, as a digital signal that can be read over USB by software.

The first physical state forms part of an overall hardware state of 3D printing system 10. The other motor metrics include the position of plate holder 36 or build plate 26 relative to resin container 20 as controlled by first motor 24, and the voltage and rotation of first motor 24.

Rather than using feedback from first motor 24, these other motor metrics may be determined using a rotary or linear encoder that can be attached to vertical shaft 34 of linear actuator 22 driven by first motor 24. The rotary or linear encoder can report the degree of rotation of vertical shaft 34 or linear distance traveled by build plate 26.

Projector 28 of the depicted embodiment is an ultraviolet (UV) light projector that is positioned below resin container 20 in use. Projector 28 is orientated such that it projects an image from below onto a bottom side of the clear release film base 32 of resin container 20. As well understood by the skilled person, light from the image travels through clear release film base 32 and cures a portion of the photosensitive resin on the other side of clear release film base 32 to form a layer or a part of a layer of the part.

As each subsequent layer or slice of the print cures, the motor driven linear actuator 22 typically moves build plate 26 up a set distance to allow the cured resin to release from the clear release film, and then retracts (moves back down) the previous travel distance minus the desired layer height. In the present case, the part to be printed with printer assembly 14 is one with complex geometries, such as lattices, microstructures and metamaterials.

Turning to processor 12, processor 12 is coupled to first motor 24 and projector 28. It is configured to receive electronic signals representing the first physical state of first motor 24 from first motor 24. As noted above, the first physical state is the current physical characteristics or motor metrics of first motor 24. Such metrics may also include the first motor's position, rotation, torque, and/or voltage. Processor 12 may receive the first physical state from firmware of first motor 20.

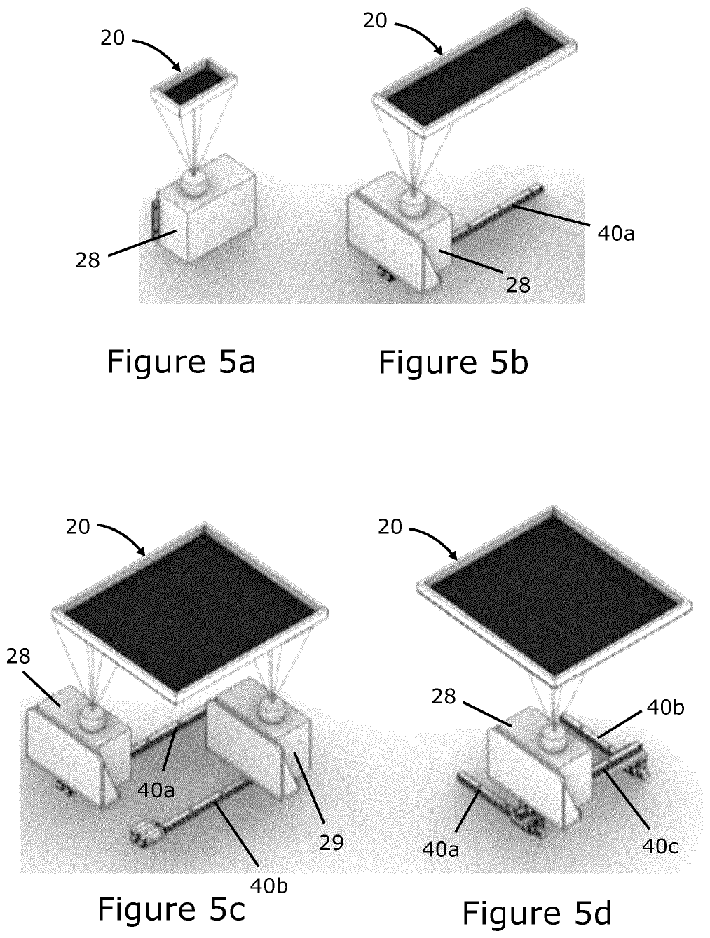

While not shown in the figures, 3D printing system 10 may include a second motor operatively coupled to projector 28, for example, as the 2-Axis Digital Light Projection (2ADLP) configuration of FIG. 5b described in further detail below. In such applications, the second motor would be operatively coupled to projector 28 to move projector 28 along one or more rails. Processor 12 would also be coupled to the second motor and be configured to receive a second physical state of the second motor. The second physical state of the second motor similarly comprises one or more of the rotation, torque, and voltage of the second motor, and the position of projector 28 relative to resin container 20. In alternate applications, the second motor may instead by operatively coupled to build plate 26. The second physical state also forms part of the overall hardware state. Processor 12 may receive the second physical state from firmware of the second motor.

In certain cases, 3D printing system 10 may include a second projector, such as in Parallel Axis DLP (PADLP) setup of FIG. 5c, also described in further detail below. There, the second motor may be operatively coupled to both projectors, or 3D printing system 10 may include a third motor operatively coupled to the second projector to move it along one or more rails. Processor 12 would also be coupled to the third motor and be configured to receive a third physical state of the third motor. The third physical state of the third motor similarly comprises one or more of the rotation, torque, and voltage of the third motor, and the position of the second projector relative to resin container 20. The third physical state also forms part of the overall hardware state. Processor 12 may receive the third physical state from firmware of the third motor.

While the hardware state can be obtained by querying the motors after they have stopped moving, as described above, in some examples, the hardware state may be simulated. In other words, the software may establish a theoretical hardware state that it expects the motors to achieve.

Processor 12 is further configured to receive one or more geometric primitives, where the geometric primitives are mathematical representations that define elements or components of the part to be printed, including its complex geometry. The term “complex geometry” as used herein refers to geometry that is physically printed, but not explicitly created or generated as digital representations. The complex geometry or geometries may be defined using one, or a combination of, geometric primitives. Overall, each geometric primitive defines one of the elements of the part, where at least one of the geometric primitives define the complex geometry portion of the part. The elements combined together form the part with the complex geometry/geometries.

The “complexity” of the geometry to be printed using 3D printing system 10 refers to the size, density and/or degree of curvature of the features of the object to be printed. For example, a geometry that exceeds a certain size threshold, a certain density threshold or a certain degree of curvature threshold (which thresholds may be defined based on the operating parameters of conventional 3D printers, and/or may be defined based on the average size, density and/or degree of curvature of conventional geometries).

Such complex geometries may include very small features with respect to the overall dimensions of the build volume (such as a lattice cell that is 0.1 mm in a build volume that is 300 mm wide). Another example is printing an array of 100M lattice cells inside a 10 cm cube, since the lattice unit sizes are extremely small relative to the overall dimensions of the cube, and there is a large variation in the curvature of surface that defines the shape. A large variation in curvature of the surface that is printed (e.g., twists, bumps, and indentations in the surface of the print ranging 0.001 mm to 1000 mm or more) may also be a complex geometry. As well, as used herein, “microstructure” refers to 3D printed structures where the thickness of each strut ranges from 0.2 to 0.5 mm.

In that manner, the geometric primitives may be one or more of point clouds, a collection of points, lines or triangles, meshes, quadrilateral meshes, NURBS, BREPs, implicit surface equations, numerical distributions, fields, data streams, textual specifications (e.g., a specification to blend seamlessly between two different surfaces), and spatial transformations representing the part and its complex geometry. The geometric primitives may be provided to processor 12 by a user.

Then, processor 12 applies the hardware state to “generators”. A generator, as used herein, is a piece of code (e.g., a function or algorithm) that evaluates points in an image plane, applying the geometric primitives with the hardware state to determine whether each pixel projected by projector 28 should be “on” or “off” when projected onto the resin (as discussed above). Example generators include: (1) Winding number calculation (which does not require hardware state); (2) Inverse Distance Transform to define an SDF based on primitives; (3) Blending between two geometries; (4) Boolean union of two geometries (as SDFs); and (5) evaluation of functions for each (x, y) pixel coordinate; among other possibilities.

For each image plane, processor 12 is configured to evaluate an instance of the generators using the hardware state to render an image of at least a portion of a slice of the part. The hardware state provides the 3D coordinates of the boundaries of the desired slice or partial slice. In a simple application of printer assembly 14 with a single vertical axis, for example, the hardware state returns the z-height, which is used to generate an appropriate horizontal slice through the geometry.

For example, the geometric primitive may be an implicit function defining the surface to be printed, such as: cos(x)+cos(y)+cos(z)=0. The generator may combine the geometric primitive with the hardware state, such as z=0.65. Each pair of (x,y) pixel coordinates in the plane will either satisfy the equation or it will not. If a pixel at coordinate (x,y) satisfies the relationship, the pixel is turned “on” (e.g., coloured white), otherwise the pixel is turned “off” (e.g., coloured black). This is the image that will be outputted based on the geometric primitive together with the hardware state. In alternate applications, the image generated may be a full colour image with a transparency channel (e.g., RGBA32F) or a greyscale image. A generator may then be used to decide which pixels should be black or white, which is then used to cure the resin. If printer assembly 14 involves multiple axes, the set of available pixels to be evaluated may be constrained by the hardware state. Processor 12 comprises CPU 16 and GPU 18. In such applications, CPU 16 is configured to receive the hardware state and the geometric primitives, and GPU 18 (coupled to CPU 16 or forming a part of CPU 16) is configured to evaluate the instance of the generators using the hardware state to render the image of the slice or partial slice of the part to be cured. In other applications, rather than GPU 18, a similar massively parallel computation unit may be used to evaluate the instances of the generators using the hardware state to render images of the slices or partial slices of the part.

At least one of the generators may apply signed distance fields (SDF) or implicit surfaces, such that the generator is or creates a SDF representation of the complex geometry. For example, a very simple generator is one for rendering a box (such as a cube). The input to the box generator is a sequence of 19 numbers (i.e. bounds of the box and its position/orientation in space), as well as the hardware state of the associated printer assembly 14. The code of the box generator uses the inputs to calculate the shortest distance from the box to any other point. Points inside the box will have a negative distance, points on the boundary of the box will have distance of 0, and points outside the box will have a positive distance. This measurement is known as the “signed distance”. When executed on GPU 18, this generator will yield a grey-scale image corresponding to the intersection of the box and the current image of the slice/partial slice to be cured.

The definition of the SDF will usually depend on the hardware state, in that the generators create SDF representations of the complex geometry from the input hardware state. However, definition of the SDF could take place without that information. In some examples, a “global” SDF that captures the entire 3D geometry to be printed may be defined. A “local” SDF representations that only capture the geometry as needed (e.g., in a slice or partial slice to be immediately printed) may also be generated. This helps to allow for faster computation.

A further example of a generator is one that creates lattice geometry. This may take a variety of forms: the lattice geometry generated by the generator may be printed directly, it may be used as infill for a shell geometry provided by a different generator, or it may be used as an exterior support for geometries that have overhanging parts or otherwise unprintable or delicate regions. While the use of lattices in 3D printing is common, printing directly from an SDF representation of lattices facilitates a much higher level of detail and ease of use.

In the present embodiment, the user provides processor 12 with the generators. However, processor 12 may also create any additional generators that are not provided by the user, but may nonetheless be required by CPU 16. In that case, CPU 16 may be further configured to create these additional generators. In such a case, multiple generators (including the additional generators) may be combined and evaluated to render each image of the slice/partial slice of the part.

These additional generators are also functions or algorithms, but may run on CPU 16 rather than GPU 18. The additional generators are not geometric primitives, as not every algorithm is a good candidate for GPU computation. GPU 18 enables massive parallelism, which makes it powerful for computing rendering tasks (such as, each pixel can be handled concurrently). In contrast, CPU-based tasks may require information from multiple locations in a sequential fashion.

An example of an additional generator, primarily used in cases seeking to fix “broken” meshes, is the calculation of a winding number for a collection of user-provided triangles (the geometric primitive) to output a higher-quality triangle mesh, or an SDF representation of the geometry. In such applications, the geometric primitives provided by the user may include a collection of triangles, usually which represents a recognizable shape. The additional generator computes the winding number of any given point with respect to the shape. The winding number is a well-known mathematical measure of the “inside-ness” of a point with respect to a shape. The algorithm that computes this number is not easily implemented on GPU 18, so processor 12 may run this generator on CPU 16. Similar to the above box generator, the result is a grey-scale image. This winding number generator can be combined with other generators by processor 12. The computation of the winding number may be applied before the hardware state is inputted.

A common set of generators that work together to produce the final image is set out below:
-SDF Box generator A: creates a greyscale image that represents the SDF of a box at some location,
SDF Box generator B: creates a greyscale image that represents the SDF of a box at some other location,
SDF Union generator: uses the output of A and B and combines them into one greyscale image that represents the union SDF of the two boxes,
Threshold generator: uses the output of the Union (i.e. a greyscale image) and decides which pixels should be fully white or fully black. This used to cure the resin.

All generators run on CPU 16 or on GPU 18. Most of the generators described above have been developed to run on GPU 18, which may result in faster computation times, as noted above. However, some generators, like the winding number generator, do not have a parallel formulation, and such generators may be implemented on CPU 16. In each case, however, the interface for all of the generators is the same, i.e. the input consists of the hardware state and a set of geometric primitives, and the output is an image for projecting onto the resin.

For a single instance in the evaluation of the generators, a standard on-board GPU/CPU is sufficient. However, in applications where the number of instances is scaled up, and especially if large build volumes are targeted using multiple axes, 3D printing system 10 can be configured to offload the slice generation to an external system, for example a high performance server array (such as a cloud computing platform). In this configuration, a minimal CPU/GPU set up would be installed on 3D printing system 10. A web-based application may be used to enable the user to define and upload geometric primitives to an external system, and to connect the external system to 3D printing system 10. The images of the slices/partial slices may then be generated in the cloud and downloaded on a per slice/partial slice basis by the local printer. Since the amount of data being transmitted is bound by the resolution of the projector 28 (such as a 1920×1080 image or similar), the transmission time for transmitting a single image of a slice/partial slice from the external system to be printed by the local printer may be on the order of a fraction of a second (assuming a high-speed internet connection).

Each rendered image of at least a portion of a slice of the part is then sent to projector 28, which projects the image onto clear release film base 32, which cures a portion of the photosensitive resin to form at least the portion of the slice of the part.

Thus, a shape (e.g. cube) filled with a lattice pattern may be printed with the above system, but a digital model of the entire cube-filled-with-lattice is not created/generated. The generators combine the geometric primitives with the hardware state to output images representing slices or partial slices forming part of the total complex geometry.

As such, 3D printing system 10 is adapted for printing a complex geometry (or complex geometries) at the mesoscale, namely large-scale objects with 0.1 mm to 5 mm features.

FIG. 5a illustrates an example of a Single Axis Digital Light Projection (1ADLP) setup, which shows resin container 20 and projector 28 of the setup described above in 3D printing system 10, which has a single vertical rail or shaft 34 orientated along the Z-axis. In the depicted embodiment, projector 28 is positioned under resin container 20 so as to project an image plane (or have a projection area) that matches the size of release film base 32 of resin container 20.

In the 1ADLP configuration, the build area of the printer is constrained by the desired XY resolution of the printed parts and the resolution of projector 28. For example, if a part resolution of 50 microns (0.05 mm) is desired and a 1080p projector (1920×1080 pixels) is used, the maximum build area in the XY plane will be 96 mm×54 mm.

However, 3D printing system 10 may have different printer configurations with additional motors and projectors. An advantage of using one the alternate setups described below is that they allow for an increase in resolution and build area of the printed part.

FIG. 5b illustrates an example of a 2-Axis Digital Light Projection (2ADLP) setup, where polymer resin is cured by moving UV projector 28 continuously along a linear rail 40a (such as long the X-axis). In this manner, the projection can be translated along the rail axis, thereby increasing the total build area without sacrificing quality (i.e. resolution).

The position of build plate 26 and projector 28 is measured via first motor 24 or their dedicated servo motors and sent as feedback (i.e. as part of the physical/hardware state) to processor 12. Processor 12 in turn evaluates the generators using that hardware state by allowing the projection to update based on the absolute position of projector 28 (i.e. to evaluate the generators).

In cases as shown in FIG. 5b, release film base 32 of resin container 20 may be larger than the projection area (or projected image plane) of projector 28. Thus, in the present case, projector 28 may no longer project an image that cures an entire slice of the part when projecting onto the resin, as illustrated in FIG. 5a. Rather, processor 12 may generate an image of only a portion of the slice of the printer part for projector 28 to project. Thus, the image projected by projector 28 may only fall on a portion or section of release film base 32 of resin container 20, and only cure a section or a portion of a slice (e.g. a fractional component) of the part.

As the second motor moves projector 28 along rail 40a, 3D printing system 10 uses the hardware state (such as the position of projector 28) and the geometric primitives in the generators to generate another image that cures another portion of the same slice. Such a feature allows 3D printing system 10 to print large parts at a scale that typically cannot be achieved with traditional 3D printers. In particular, the use of the hardware state allows 3D printing system 10 to ensure that the separately cured portions of the same slice align to form a working or correct slice of the product.

When the movement along linear rail 40a is done, build plate 26 is incrementally moved up perpendicular rail (the Z-axis) or vertical shaft 34 by a small amount. In some applications, first motor 24 may be coupled to control and move both build plate 26 and projector 28 along rail 40a. Alternately, a separate servo motor, such as the second motor, may be coupled to move projector 28 while first motor 24 moves build plate 26.

FIG. 5c illustrates an example of a Parallel Axis DLP (PADLP) setup that includes a second UV projector 29 moveable along a second linear rail 40b that is parallel to the first linear rail 40a (such as long the X-axis). First motor 24 may be coupled to control and move build plate 26, and both projectors 28, 29 along their respective rail 40a, 40b. The positions of projectors 28, 29 may be included in the hardware state and used to evaluate the generators. Alternately, a separate motor may be coupled to build plate 26 and to each projector 28, 29 to move the projectors along their respective rails 40a, 40b.

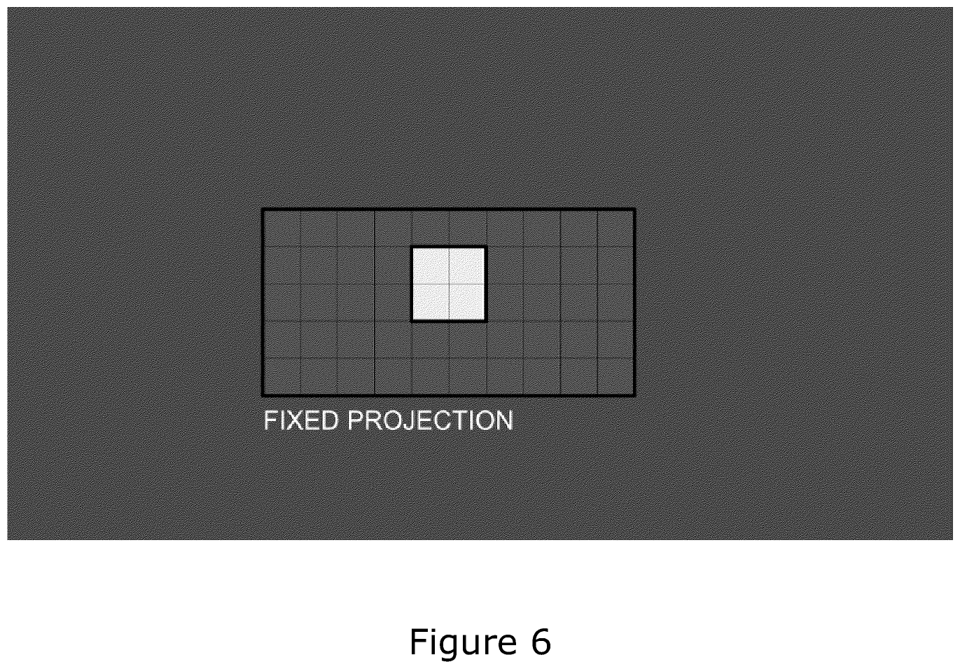

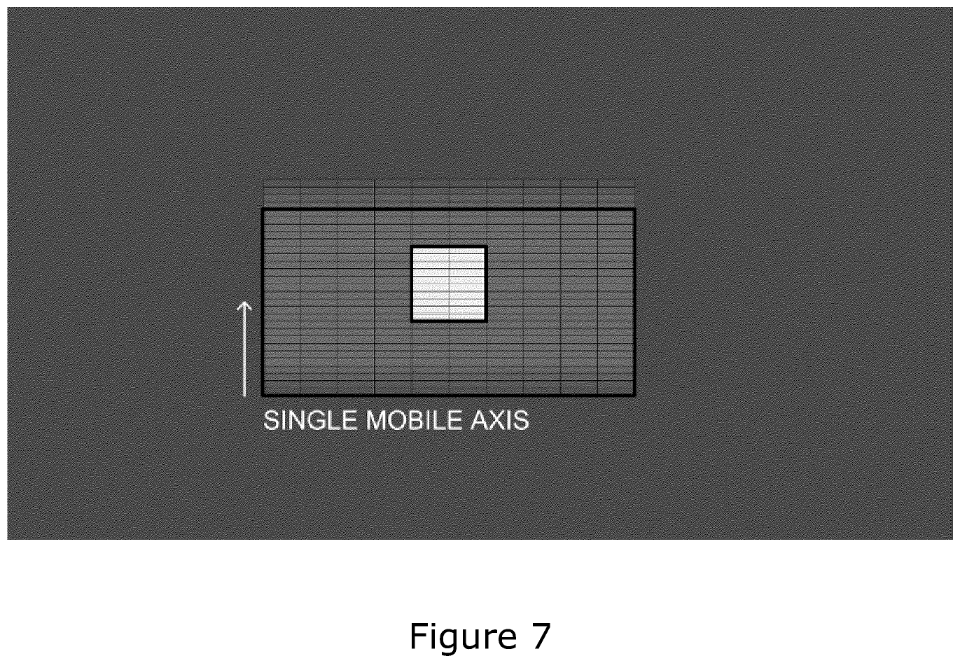

The build area can be further enhanced by adding additional projector 29 along parallel linear rail 40b, as in the PADLP setup. A goal of both the 2ADLP and PADLP setup is to obtain increased resolution beyond the intrinsic resolution of projectors 28, 29. When projectors 28, 29 are moving along an axis of travel, the resolution in that axis is dictated by the precision of the servo motor and linear axis rather than the XY resolution of the projected image. See the comparison as shown between FIGS. 6 and 7. If the minimal travel distance along linear rail 40a (for example) is smaller than the pixel size of projector 28, the resolution in the direction of the axis' motion can be increased. FIG. 6 illustrates that the fixed projection allowed by the 1ADLP configuration creates a highlighted portion with 4 pixel resolution capabilities. FIG. 7 shows that the projection can be translated continuously and/or with discrete steps (in the direction indicated by the arrow) that are smaller than the regular pixel size. In this manner, sub-pixel curing in the direction of projector travel (see arrow) can be achieved.

FIG. 5d illustrates an example of a Multi-Axis DLP (MADLP) setup, which is similar to PADLP setup, except that a single projector 28 is moved in both X and Y directions by two perpendicular linear rails (or belt drives) 40a, 40b, 40c. In such cases, the second motor may operatively control projector 28 along both axes, or multiple motors may be employed to control projector 28 along both axes.

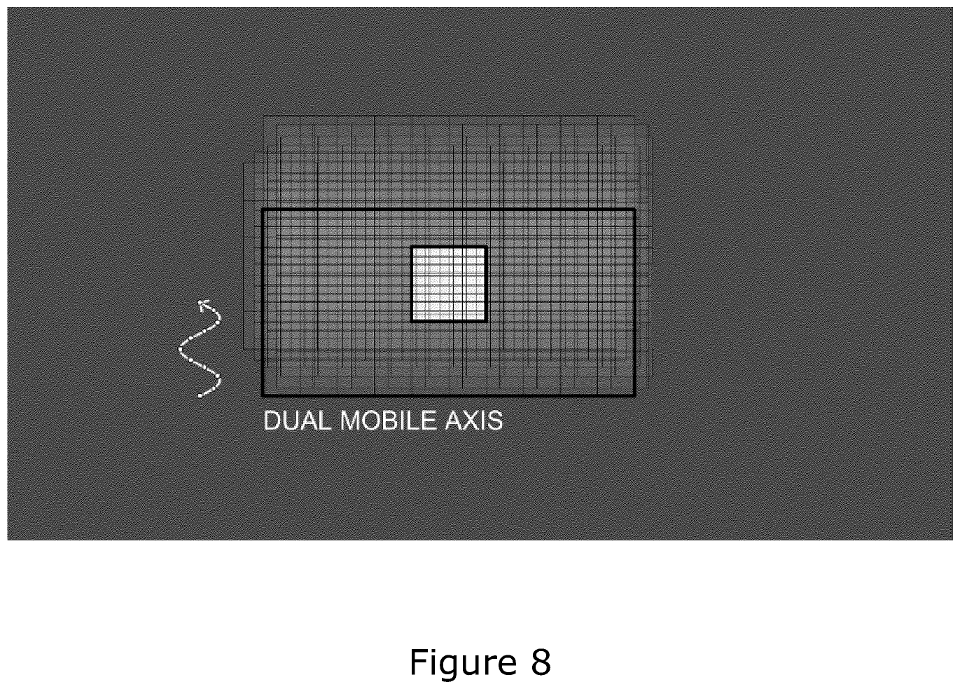

The MADLP setup could also extend the build area again without a loss of projector resolution. In this dual-axis setup, the linear motion of one of the projector axes could be coupled with a sinusoidal motion in the second axis to allow for sub-pixel resolution in both X and Y while scanning across the projection plane, see FIG. 8. By putting the projector on a mobile axis, a very small (and high resolution) projection plane can be used to cure a large area of resin. FIG. 8 illustrates that by continuously translating the projection, the pixel grid may be further divided. The sinusoidal motion is one example of motion that could increase the resolution of the print, where the actual movement of projector 28 is more likely to be controlled based on the geometry being projected. By moving projector 28 along both axes while scanning across the projection plane, it is possible to increase the resolution of the fixed pixel grid by moving projector 28 in increments smaller than the pixels being projected.

An additional advantage when using such set-ups include the possibility of creating large prints with separate cure areas (i.e. disconnected areas beyond the reach of a single, fixed projection). In that manner, release film base 32 of resin container 20 shown in FIGS. 5c and 5d may now be even larger than the resin container 20 of FIG. 5a or 5b and produce even larger printed products. The separate cure areas may be moved to directly with rapid repositioning of projector 28 (i.e. moves faster than the typical scan speed required for resin curing), since processor 12 renders only the image of the (partial) slices needed for the relevant areas of the build volume. This may help to reduce individual cure times by avoiding slow travel over build areas that do not require active curing. Feedback about the position(s) of projector(s) 28, 29 can also be received by processor 12 to facilitate larger build volumes.

The use of the hardware state as inputs to the generators (per slice image evaluation) is important in the present applications for a number of reasons.

If the positions to which build plate 26 and/or projector 28 are directed to go to (by their respective motors) are different from where build plate 26 and/or projector 28 actually are during a print, the corresponding pixels of the projected image are not adjusted when projected on the base 32 of resin container 20, and precision of the final printed part will be lost. Indeed, if the features of the part to be printer are small enough, this mismatch may cause the part to fail. Since the present subject matter is concerned with printing parts with very small features, it is important that exactly those pixels that represent the part (as determined by the position of build plate 26 and/or projector 28) are cured. Evaluating the generators with the actual positions of plate 26 and/or projector 28 (through the hardware state input) will assist in that regard.

Using the hardware state as input to the generators also allows for adding of additional axes (as described above) with only slight increase in the complexity of the generators that are being evaluated. Equipped with this generalized way of handling multiple axes, printer configurations with a single axis, a double axis, parallel axes, etc. can be used.

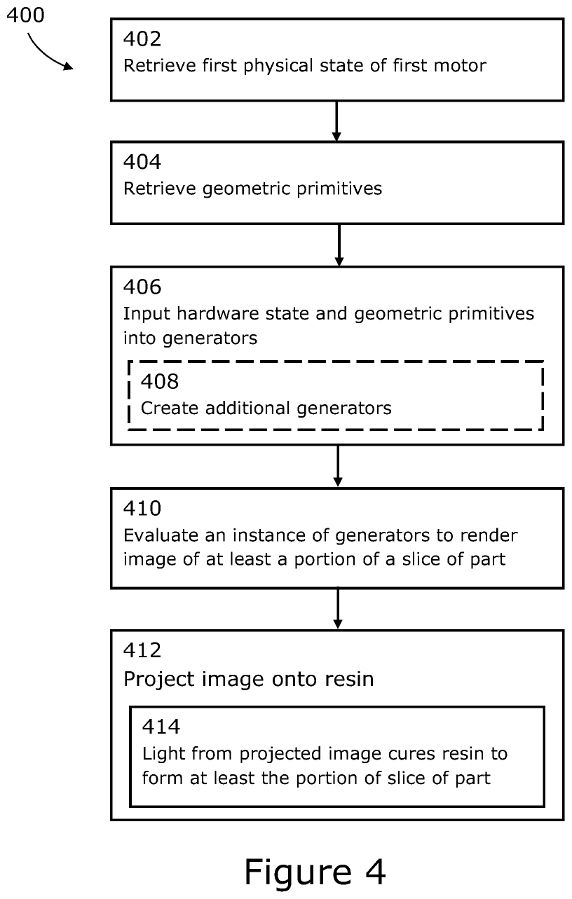

FIG. 4 is a flowchart setting forth the steps of an example method 400 for printing a part with a complex geometry or complex geometries using a 3D printing system. In some examples, method 400 may be at least in part be performed using 3D printing system 10 as described above. Additionally, the following discussion of method 400 leads to further understanding of 3D printing system 10. However, it is to be understood that 3D printing system 10 and method 400 can be varied and need not work exactly as discussed herein in conjunction with each other, and that such variations are within the scope of the appended claims. As well, method 400 may be performed independently of 3D printing system 10.

As an initial step, if not already done so, 3D printing system 10 is set up for printing, including adding resin to resin container 20, and lowering build plate 26 to base 32 of resin container 20.

At 402, the first physical state of first motor 24 is retrieved, where the first physical state comprises characteristics or metrics of first motor 24 and forms part of the hardware state of 3D printing system 10. The first physical state of the first motor comprises one or more of more of rotation, torque, voltage, and position of a build plate as controlled by first motor 24. The first physical state may be retrieved from a memory, inputted by a user, or received from first motor 24, such as from firmware of first motor 24.

Retrieving the first physical state of first motor 24 may include sending a generic set of movement commands to first motor 24 in order to determine the motor metrics of the first physical state. Firmware of first motor 24 may determine and record the motor metrics and send them to processor 12. Processor 12 will use the motor positions as primary inputs to preparing an image of the (partial) slice. Therefore, the image of the (partial) slice is necessarily prepared after first motor 24 has been moved. Traditional 3D printers usually require the slices to be generated before the motors have moved into position.

In applications where 3D printing system 10 comprises a second motor, method 400 may further include retrieving a second physical state of the second motor, where the first and second physical states collectively form the hardware state of 3D printing system 10. Similar to the first physical state, the second physical state of the second motor comprises one or more of the rotation, torque, voltage, and position of projector 28 as controlled by the second motor.

At 404, geometric primitives are retrieved, where the geometric primitives are mathematical representations of the complex geometry or geometries of the part to the printed. The geometric primitives may include one or more of a collection of points, lines or triangles, implicit surface equations, numerical distributions, and spatial transformations. The geometric primitives may be retrieved from memory, or inputted by a user.

The lattice and/or geometry specifications may be loaded onto processor 12 as OBJ files describing a single unit cell, or STL files describing the boundary of a desired volume to be filled with lattices. These may also be other types of data streams, such as point clouds or other text-based representations of geometry. In cases where a lattice is to be printed, one or more lattices from a library of implicitly defined representations may be loaded. Examples include Triply Periodic Minimal Surface (TPMS) lattices which are described by a Fourier approximation, or other periodic surface-based lattices.

The desired build volume, or shape to be populated with lattice is also determined and entered into processor 12. Scale, periodicity, node and beam radii, beam hollowing, surface textures (e.g. roughness), gradients, hybrid lattice types, or other design parameters are also modified as needed. Boolean operations (e.g. union, intersect, difference) may also be performed.

At 406, the hardware state is inputted into generators by processor 12. For example, the user could select which generators to use through the user interface. Generators evaluate points in an image plane, using the hardware state, to determine whether each pixel projected by projector 28 should be “on” or “off” when projected onto the resin. According to method 400, at least one of the generators applies signed distance fields (SDF) or implicit surfaces to the inputs to create a SDF representation of the complex geometry.

As noted above, a common problem with the conventional mesh-based workflow for preparing a model and submitting it to a 3D printer is that the mesh is not watertight, or has some other irregularity.

“Watertightness” refers to the property of a mesh to “hold water”, i.e. have no holes or tears in the mesh. In practice, this is very hard to achieve because most CAD applications use single or double precision floating point numbers to represent the coordinates of the mesh vertices. Typical CAD operations (such as trimming, splitting, Booleans) quickly require more precision that these data structures can provide. This causes very subtle holes in the mesh.

Even if the surface of a mesh is watertight, self-intersection or non-manifoldness may occur. The mesh may still be twisted and stretched to intersect with itself, even becoming non-manifold. When this happens, many typical CAD operations fail.

These are typically referred to as “broken” meshes. Most known 3D printers have limited computation capacity on-board, so when confronted with a broken mesh, the printer either refuse to process it further, or proceeds with the print and produces a faulty or unusable result.

Use of SDFs is robust because they do not depend on meshes having these conditions in order to produce a well-defined result, whereas typical mesh slicers do. Consequently, the present 3D printing system 10 can print a broken mesh by evaluating the SDF of each triangle in the user provided mesh, and then take the union over all the triangles. The original triangle mesh, and the resulting SDF, will usually have zero thickness. Thus, to physically realize this geometry as a 3D printed object, it will require the walls to have some non-zero thickness. As such, this resulting SDF can be thickened by a small amount and used to evaluate if a pixel in a given image of the (partial) slice should be cured by projector 28 or not.

Optionally, at 408, method 400 also includes creating additional generators, wherein the image of the (partial) slice of the part is evaluated from a combination of the generators and the additionally created generators.

As noted above, an example of an additional generator is the calculation of a winding number for a collection of user-provided triangles. If the geometric primitives provided by the user includes a collection of triangles, usually which represent a recognizable shape, the additional generator computes the winding number of any given point with respect to the shape.

The calculation of the generalized winding number may be performed as provided by Barill et al. “Fast winding numbers for soups and clouds”, ACM Transactions on Graphics, Vol. 37, No. 4, Article No.: 43, July 2018, where a smooth version of the winding number over a set of triangles is computed. This function can be evaluated to determine if a pixel is “inside” or “outside” that set of triangles (i.e. mesh) even if that mesh does not have a geometrically well-defined interior, due to non-manifoldness or non-watertightness, as described above.

These generator operations are robust to any user defined mesh. Moreover, some generators can produce very small scale meshes that can act as supports. By combining these elements, a viable print can be created from even the most broken mesh.

With geometry represented by signed distance fields, the printing parameters are set, such as smoothing (via anti-aliasing), and thickness of each (partial) slice (Z-height).

At 410, for each image plane, the generators (and additional generators, if applicable) are evaluated using the hardware state to render an image of at least a portion of a slice of the part. Using information about the position of projector 28, processor 12 begins to render images of such slices/partial slices, representing the 3D geometry as a series of 2D black and white images. Each pixel is coloured black to represent void, or white to represent solid. In alternate applications, the image may be a full color image with a transparency channel (RGBA32F) or a greyscale image. A generator is then used to determine whether the coloured or grey pixel is to be projected onto the resin.

That rendered image of the slice or partial slice is then projected at 412 as an image onto resin through clear release film base 32, which cures a portion of the resin to form at least the portion of the slice of the part. In the present embodiment, the projecting comprises projecting the slice with UV light onto photosensitive resin to form a layer or partial layer of the part. The images of the (partial) slices are sent to printer assembly 14 one at a time, with the next image being prepared while printer assembly 14 is curing and repositioning after each (partial) slice image is projected.

In cases when release film base 32 of resin container 20 is larger than the projection area (or projected image plane) of projector 28, the image rendered and projected is of a portion of the slice, or a partial slice, of the part. This image of a portion of the slice is projected onto a section of release film base 32 of resin container 20, and only cures a section or a portion of the slice (e.g. a fractional component) of the part.

As the second motor moves projector 28 along one of the rails, method 400 may be repeated to render another image that cures another portion of the same slice. Such a feature allows 3D printing system 10 to print large parts at a scale that typically cannot be achieved with traditional 3D printers. In particular, the use of the hardware state allows 3D printing system 10 to ensure that the separately cured portions of the same slice align to form a working or correct slice of the product.

Once all the images of the (partial) slices have been rendered and sent to printer assembly 14, and projector 28 has projected each image of the slices or partial slices, the print is complete. The geometrically complex part can be removed from build plate 26, and treated using standard methods for photo-sensitive resins (e.g. washing in alcohol to remove excess resin, and optionally cleaning via ultrasonic cleaner or using a UV-curing device).

In this regard, unlike traditional 3D printing methods, method 400 does not require a user to create a detailed CAD model of the object to be printed. The full design to be printed is not evaluated. Rather, the generators are only evaluated for the slice or partial slice being printed, and the final printed part is realized by repeatedly evaluating the set of generators using the hardware state. Thus, method 400 allows for printing of vastly larger volumes of much more detailed geometry than existing methods, with less time and memory requirements than existing methods. Also, the exact location of the image plane is determined by the motor positions of the various axes, not by interpolating a pre-set layer thickness.

As noted above, method 400 can be implemented using 3D printing system 10. However, it may also be realized using systems with a different configuration, such as those described above with a different number and position of linear rails. In these cases, the motor positions relative to each rail may be included in the hardware state and used to evaluate the set of generators, which define the part to be printed.

The following are some examples of the benefits of using the hardware state to evaluate the generators for printing parts with complex geometries.

### Example 1: Pixel Correction for Z-Axis Movement (i.e. Main Build Plate Axis)

As part of the hardware state, rotation of the motor that controls Z-axis is measured. In a scenario without pixel correction, which is representative of all “open” loop systems (i.e. systems that do not use hardware state as input), the Z-axis motor is incrementally rotated by a pre-determined amount. In so doing, it moves the build plate vertically upwards.

The user provides a desired layer thickness, for example 0.05 mm. In the control software, this layer thickness can be converted to the appropriate motor command. After waiting a pre-set amount of time (i.e. the estimated time that it takes the motor to complete its movement), the image corresponding to the build plate location is projected and the resin is cured.

The problem with this system is that the actual build plate location may be different from the target location as calculated by the processor. For example, on the first slice, the actual location may be 0.049 mm, whereas the target location is 0.05 mm. Over many slices, this error can compound and produce a part that is shorter or taller than the design intent. Furthermore, if the design intent has a feature that is smaller than the 0.001 mm error, albeit small, then the image being cured could skip that feature entirely.

In the present case, with pixel correction using the hardware state, the setup is the same as described above. However, after the processor sends the command to rotate the motor, it compares the actual rotations completed by the motor with the target rotations. This difference is converted to the Z-axis position of the build plate and provides it as input to the generators responsible for creating the pixels to be cured by the projector. Since the generators received the actual build plate location, the correct pixels will be cured.

### Example 2: Projector that Moves Continuously on X-Axis

The hardware state measured includes rotation of the motor that controls X-axis. In this scenario, the resin container (i.e. the build volume) extends beyond the projector's image plane in the X-axis. For example, the build volume is 2× wider in the X direction than the projector's image plane.

For each overall slice or layer, the projector must start at one end of the resin container/build volume and move continuously across the resin container as controlled by the X-axis motor. In order to properly cure the resin in the desired shape, the projector must update the pixels if the X-axis motor's rotation results in X-axis movement that exceeds the pixel's dimensions in the image plane.

After the processor sends the command for the X-axis motor to rotate until the full width of the resin container has been traversed, it then repeatedly queries the motor for its current rotation count. This is converted to the X-axis position and given as input to the generators. The generators are evaluated and the new pixels are provided to the projector.

### Example 3: Update Shape as Result of Torque, Voltage Feedback

Torque and voltage could be used in error-correction. The most basic approach would be to stop the print if an anomaly is detected in the voltage or torque (i.e. too much or too little). A more sophisticated approach would be to changing the pixels that are cured in response to the voltage and torque.

For instance, the generators (such as shaders) could adapt the density of a lattice to achieve a certain torque on the Z-axis, effectively making the print faster.

The present application further relates to a system and method for monitoring and improving a 3D printing process by monitoring the torque experienced by the motor.

Referring back to FIG. 1, a torque monitoring system and a method thereof are also provided. In the present embodiment, the torque monitoring system is part of 3D printing system 10 as described above. However, the torque monitoring system may be used in an alternate 3D printer. As well, this torque monitoring method may be performed independently of the torque monitoring system and/or 3D printing system 10.

The torque monitoring system comprises first motor 24 that is operatively coupled to linear actuator 22 for moving build plate 26 up and down along vertical shaft 34, where first motor 24 is configured to report its torque in real-time during the printing process. As noted above, first motor 24 is also configured to record and report the position of plate holder 36 or build plate 26 relative to vertical shaft 34 as controlled by first motor 24.

The torque monitoring system also includes processor 12, which is coupled to first motor 24. Processor 12 is configured to monitor the torque of first motor 24 in real-time, identify a predetermined torque metric during the printing process, and instruct the motor to stop moving the build plate in response to identification of the predetermined torque metric. Overall, this allows for high precision and feedback to processor 12 about the actual location of build plate 26, and allows for a number of uses.

One such use of the torque monitoring system is sensorless homing of build plate 26 at the beginning of a print. This is accomplished by moving build plate 26 down until it comes into physical contact with base 32 of resin container 20, and comes to a stop. This may be represented by a sudden jump in torque experienced by first motor 24, referred to as a contact amount of torque of first motor 24. Processor 12 may then instruct first motor 24 to stop. This helps to set the build plate's initial position at the start of a print. The contact amount of torque may also be determined prior to a printing process.

Another such use is for the identification of release of a part from release film base 32. As described above, as each subsequent layer of the print cures, the motor driven linear actuator 22 typically moves build plate 26 up a set distance to allow the cured resin to release from the clear release film, and then retracts (moves back down) the previous travel distance minus the desired layer height.

By measuring the torque on first motor 24 while build plate 26 travels up, the time at which the cured resin breaks free from the release film can be precisely determined through a sudden drop in torque experienced by first motor 24. The torque curve, while the printed part is being peeled away from release film base 32, generally increases as the part moves further away from release film base 32 until release film base 32 snaps away from the cured print part. This would correspond to a sharp drop in the torque curve. Print times can therefore be reduced by only moving build plate 26 the distance that is required for parts to release, rather than the set/predefined distance, as previously done.

The predetermined torque metric may correspond to a sudden drop in torque as build plate 26 moves up along vertical shaft 34 when the cured resin breaks free from the release film. This sudden drop in torque may be referred to as a first release amount of drop in torque of first motor 24. In such a case, processor 12 is further configured to instruct first motor 24 to stop moving build plate 26 up along vertical shaft 34 upon identification of the first release amount of drop in torque. The printing process may then resume.

Processor 12 may also be configured to record the first release amount of drop in torque, identify a second release amount of drop in torque during the printing process, and compare the second release amount of drop in torque with the first release amount of drop in torque. If the second release amount of drop in torque is less than the first release amount of drop in torque, the processor is further configured to stop the printing process. This may indicate that the part has failed to adhere to release film base 32 or that the part has failed to release. Processor 12 may send an alert to the user upon detection of a part that fails to release. If the second release amount of drop in torque is similar to the first release amount of drop in torque, the processor is configured to continue the printing process.

In some applications, if the previous layer has a larger surface area than the current layer, it would be expected that the torque experienced by first motor 24 would be less on the current layer. In such a case, the second release amount of drop in torque would be determined to be less than the first release amount of drop in torque by at least a predetermined value before the processor stops the printing process.

Part failure may also be identified using the torque monitoring system. When printing complex geometry, parts can fail for a variety of reasons and it is often difficult to identify a failure because the portion of the printed part that is actively being cured is submerged in liquid resin. Identifying these cases early in the printing process can help to reduce resin waste and save time.

By measuring torque on first motor 24 and calculating the surface area of the current layer being cured, specific failure cases can be identified. For example, if the part fails to adhere properly to build plate 26 and adheres instead to release film base 32, the torque measured when retracting will be a lower value than the previous known good layer of similar surface area.

A further use of the torque monitoring system is in helping to resume prints. For example, if the motor position is ever lost (due to power outage or other circumstances) the print can be resumed by moving build plate 26 down until the part interferes with bottom 32 of resin container 20, which can be measured through the torque values collected.

The torque metrics may be reported in real time by first motor 24 using the motor's High Level Feedback (HLFB) outputs, which outputs to processor 12 a Pulse Width Modulated (PWM) signal whose duty cycle is proportional to the torque of first motor 24. Alternately, first motor 24 may comprise a clamp-on torque cell that measures current drawn by first motor 24 to determine torque of first motor 24. First motor 24 may comprise firmware that reports torque in real-time to processor 12.

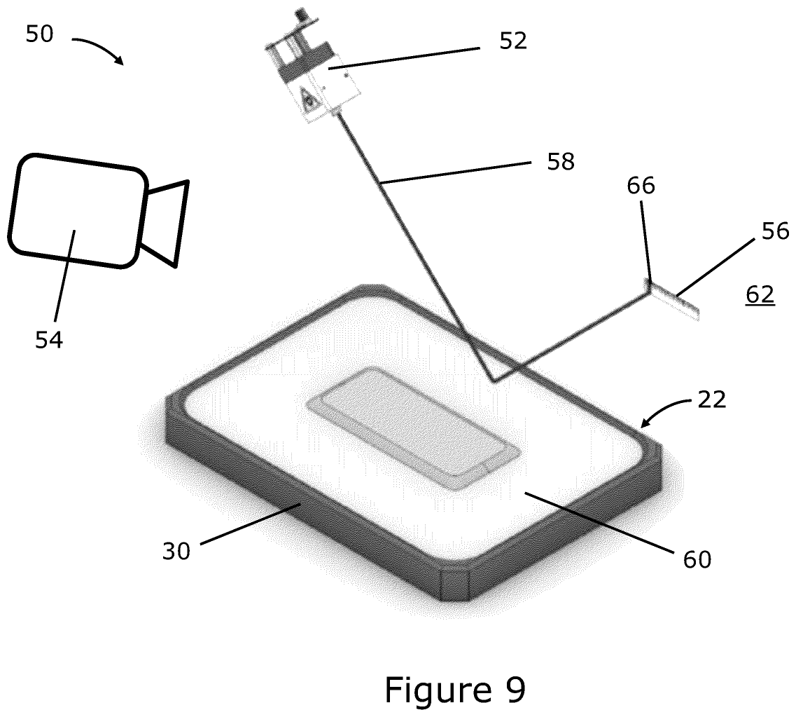

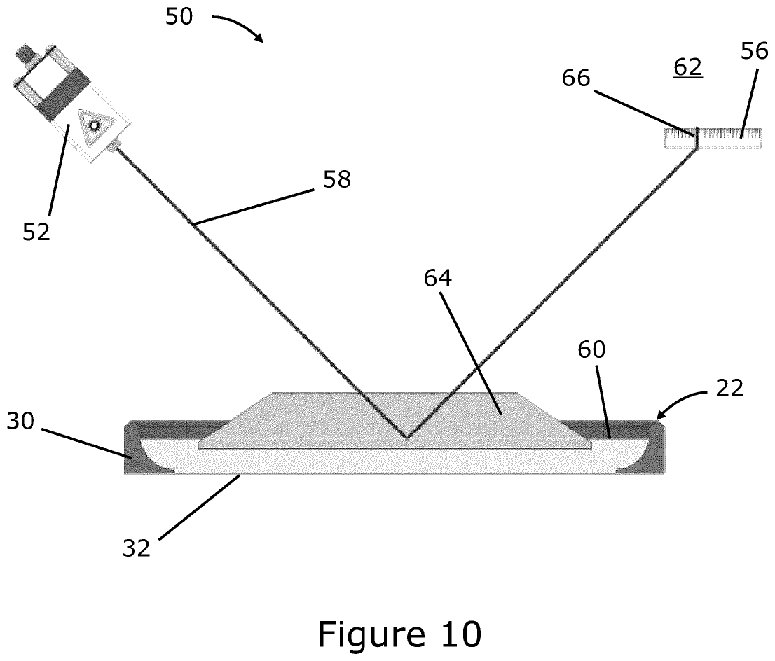

The precise measurement and monitoring of the volume and level of resin in the resin container may also be used to monitor and improve the printing process. Referring to FIGS. 9 and 10, a resin monitoring system 50 is provided. A method of monitoring resin is also provided. In the present embodiment, resin monitoring system 50 may form part of, or may be used with, 3D printing system 10 as described above. However, resin monitoring system 50 may be used in an alternate 3D printer. In either case, resin monitoring system 50 is for use with resin in a resin container that forms a resin surface. The resin monitoring method may be performed with, or independently from, the torque monitoring method and/or method 400.

Resin monitoring system 50 comprises a laser source 52 and a visual sensor 54. Resin monitoring system 50 may further comprise a reference marker 56.

As depicted, laser source 52 is positioned above resin container 20 and is orientated to direct a laser beam 58 onto a surface 60 of the resin within resin container 20 that is not obscured by build plate 26. Resin surface 60 reflects laser beam 58 onto an external surface 62 as a reflected laser point 66. In that regard, laser source 52 is orientated to direct laser beam 58 onto resin surface 60 preferably at a non-perpendicular angle.

In the present embodiment, laser source 52 is configured to generate laser beam 58 having a wavelength that is preferably far from the UV spectrum, possibly in the infrared spectrum. More preferably, laser beam 58 is generated having a wavelength of 600-700 nm, and the resin within resin container 20 is preferably a low-viscosity resin.

Visual sensor 54 is adapted to identify a position of reflected laser point 66 on external surface 62, wherein the position of reflected laser point 66 on external surface 62 indicates a level of resin in resin container 20. As the level of resin in resin container 20 changes, the position of reflected laser point 66 on external surface 62 also changes. By finding the bounds of the position of this point (i.e. position when resin container 20 is empty and position when resin container 20 is full) the full range of possible resin levels can be precisely measured in an indirect way.

As presently shown, resin monitoring system 50 includes reference marker 56 positioned on external surface 62, where the position of reflected laser point 66 on external surface 62 relative to reference marker 56 indicates the level of resin in resin container 20. Reference marker 56 may comprise metric or imperial measurement markings for finer indication of change in resin levels.

Visual sensor 54 may be a camera focused on external surface 62 where reflected laser point 66 is directed and focused on reference marker 56. In such a case, the camera is adapted to capture an image of reflected laser point 66 and reference marker 56 on external surface 62. Alternately, visual sensor 54 may be a linear optical array sensor with photo-sensing pixels, where the linear optical array sensor is adapted to generate an output representing light exposure at the photo-sensing pixels. For example, the linear optical array sensor may be an MLX75306 linear optical array chip or a Toshiba TCD2557D CCD linear image sensor.

In some application, resin monitoring system 50 may further include a reflective device 64 that is adapted to float in the resin at resin surface 60 in resin container 20. In that regard, laser source 52 is orientated to direct laser beam 58 onto reflective device 64 to reflect laser beam 58 onto reference marker 56 on external surface 62.

As a print progresses through consecutive layers, resin is hardened and removed from resin container 20 by its adhesion to build plate 26 (as the desired printed part.) The decrease in resin volume often necessitates manual refilling of resin during long prints. By measuring the level of the resin, this step can be automated with resin monitoring system 50.

In such cases, resin monitoring system 50 may further comprise a resin reservoir (not shown) that is operatively coupled to processor 12 and fluidly coupled to resin container 20, the resin reservoir holding additional resin. In turn, processor 12 may be coupled to receive the image or output from visual sensor 54 and be configured to process the image or the output to determine the level of resin in resin container 20. This may be done through a known image processing process. Having determined the level of resin in resin container 260 in real-time, processor 12 may then monitor the level of resin in resin container 20 in real-time during a printing process and identify when the level of resin falls below a predetermined level.

When processor 12 identifies that the level of resin has fallen below the predetermined level, it may then control the resin reservoir to transfer at least a portion of the additional resin therein to resin container 20.

Resin monitoring system 50 may also be used to identify part failure. The volume of cured resin (i.e. the printed part) can be calculated by tracking the number of activated pixels each image contains and multiplying by the target layer height. Given this known theoretical part volume, the actual part volume can also be measured with resin monitoring system 50. This can be achieved by first retracting the part from the liquid resin, measuring the current resin level, moving the part back into the resin and finding the displacement of liquid resin. This check may be used as an indication of “print health”. If the theoretical part volume and actual part volume are disparate by more than a predefined threshold (e.g., more than 1% discrepancy), it is likely that the print has failed in some manner.

In that regard, partway through the printing process, processor 12 of resin monitoring system 50 may be further configured to calculate the theoretical volume of cured resin of the partially formed part, determine a baseline level of resin in resin container 20 with the partially formed part removed therefrom, determine a displacement level of resin in resin container 20 with the partially formed part fully inserted therein, calculate the actual part volume by subtracting the baseline level of resin from the displacement level of resin, and compare the theoretical part volume with the actual part volume of the partially formed part. If their difference is greater than a predetermined threshold processor 12 may be further configured to send a signal to alert the user of a print failure.

The level of the resin can also be used to deduce if the part has released from release film base 32. During printing, the part is cured between build plate 26 and release film base 32. As build plate 26 travels upwards, suction and adhesive forces pull on release film 32 until the printed part releases from this film (and remains adhered to build plate). On the surface of the resin, this sequence can be measured as an initial apparent increase in the level of the liquid resin as the build plate is moving up, and a sudden drop in that level as the release film snaps away from the cured part. Print times can therefore be reduced by only moving build plate 26 the distance that is required for parts to release, rather than the set/predefined distance, as previously done.

In such a case, processor 12 may also be configured to monitor the level of resin in resin container 20 in real-time and to identify a sequence of change in the resin level, where the sequence is an initial increase in resin level followed by a sudden decrease in resin level. The sudden decrease in resin level would indicate a point in time during the printing process when cured resin breaks free from the release film.

Thus, similar to the torque monitoring system, resin monitoring system 50 may help to reduce print times by only moving build plate 26 the distance that is required for parts to release, rather than the set/predefined distance, as previously done.

While some embodiments or aspects of the present disclosure may be implemented in fully functioning computers and computer systems, other embodiments or aspects may be capable of being distributed as a computing product in a variety of forms and may be capable of being applied regardless of the particular type of machine or computer readable media used to actually effect the distribution.

At least some aspects disclosed may be embodied, at least in part, in software. That is, some disclosed techniques and methods may be carried out in a computer system or other data processing system in response to its processor, such as a microprocessor, executing sequences of instructions contained in a memory, such as read-only memory (ROM), volatile random access memory (RAM), non-volatile memory, cache or a remote storage device.

A computer readable storage medium may be used to store software and data which when executed by a data processing system causes the system to perform various methods or techniques of the present disclosure. The executable software and data may be stored in various places including for example ROM, volatile RAM, non-volatile memory and/or cache. Portions of this software and/or data may be stored in any one of these storage devices.

Examples of computer-readable storage media may include, but are not limited to, recordable and non-recordable type media such as volatile and non-volatile memory devices, ROM, RAM, flash memory devices, floppy and other removable disks, magnetic disk storage media, optical storage media (e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like. The storage medium may be the internet cloud, or a computer readable storage medium such as a disc.

Furthermore, at least some of the methods described herein may be capable of being distributed in a computer program product comprising a computer readable medium that bears computer usable instructions for execution by one or more processors, to perform aspects of the methods described. The medium may be provided in various forms such as, but not limited to, one or more diskettes, compact disks, tapes, chips, USB keys, external hard drives, wire-line transmissions, satellite transmissions, internet transmissions or downloads, magnetic and electronic storage media, digital and analog signals, and the like. The computer useable instructions may also be in various forms, including compiled and non-compiled code.

At least some of the elements of the systems described herein may be implemented by software, or a combination of software and hardware. Elements of the system that are implemented via software may be written in a high-level procedural language such as object oriented programming or a scripting language. Accordingly, the program code may be written in C, C++, J++, or any other suitable programming language and may comprise modules or classes, as is known to those skilled in object oriented programming. At least some of the elements of the system that are implemented via software and hardware may be written in assembly language, machine language or firmware as needed.

In either case, the program code can be stored on storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

While the teachings described herein are in conjunction with various embodiments for illustrative purposes, it is not intended that the teachings be limited to such embodiments. On the contrary, the teachings described and illustrated herein encompass various alternatives, modifications, and equivalents, without departing from the described embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

1-48. (canceled)

49. A three-dimensional (3D) printing system configured to print a part with complex geometry, the 3D printing system comprising:
a motor operatively coupled to a linear actuator for moving a build plate, the motor configured to report a physical state of the motor in real time during a printing process, the physical state comprising one or more of rotation, torque, voltage of the motor and position of the build plate as controlled by the motor;
a processor coupled to the motor, the processor configured to:
receive the physical state from the motor, the physical state forming part of a hardware state of the system;
receive one or more geometric primitives, the one or more geometric primitives being respective mathematical representations of respective elements of the part with the complex geometry; and
input the hardware state and the one or more geometric primitives into one or more functions to evaluate points on an image plane and render an image of at least a portion of a slice of the part; and
a printer assembly coupled to the processor for printing the 3D geometry of at least the portion of the slice of the part.

50. The 3D printing system of claim 49, wherein the one or more geometric primitives comprise one or more of a collection of points, lines or triangles, implicit surface equations, numerical distributions, spatial transformations, polygons, data fields, surface textures, volumetric representations including meshes, Non-Uniform Rational Bezier Surfaces (NURBS), Boundary Representations (BREPS), and point clouds.

51. The 3D printing system of claim 49, wherein the processor comprises:
a central processing unit (CPU) that receives the hardware state and the one or more geometric primitives, and
a graphics processing unit (GPU) coupled to the CPU that evaluates the one or more functions using the hardware state and the one or more geometric primitives to generate an appropriate slice representation of the geometry of the part.

52. The 3D printing system of claim 51, wherein one or more geometric primitives is represented by the collection of triangles, at least one of the one or more functions computes a winding number of any given point with respect to the geometry of the part and generates a new representation of the geometry of the part based on the computed winding number.

53. The 3D printing system of claim 49, wherein at least one of the one or more functions computes a full or partial signed distance field (SDF) representation of the complex geometry to be printed directly.

54. The 3D printing system of claim 49, wherein at least one of the one or more functions creates one or more of lattices, microstructures and metamaterials.

55. The 3D printing system of claim 49, wherein the processor is further configured to create one or more additional functions, wherein the whole or a slice of the part is evaluated with at least the one or more additional functions.

56. A method of three-dimensional (3D) printing of a part having complex geometry with a 3D printing system, the method comprising:
retrieving a physical state of a motor, the physical state comprising metrics of the motor including one or more of rotation, torque, voltage, and position of a build plate as controlled by the motor and forming part of a hardware state of the 3D printing system;
retrieving one or more geometric primitives, the one or more geometric primitives being respective mathematical representations of respective elements of the part with complex geometry;
inputting the hardware state and the one or more geometric primitives into one or more functions to evaluate a 3D geometry to be printed of at least a portion of a slice of the part; and
printing, by a printer assembly of the 3D printing system, the 3D geometry of least the portion of the slice of the part.

57. The method of claim 56, wherein the one or more geometric primitives comprise one or more of a collection of points, lines or triangles, implicit surface equations, numerical distributions, spatial transformations, polygons, data fields, surface textures, volumetric representations including meshes, Non-Uniform Rational Bezier Surfaces (NURBS), Boundary Representations (BREPS), and point clouds.

58. The method of claim 57, wherein the one or more geometric primitives is represented by the collection of triangles, at least one of the one or more functions computes a winding number of any given point with respect to the geometry of the part and generates a new representation of the geometry of the part based on the computed winding number.

59. The method of claim 56, wherein retrieving the physical state of the motor comprises moving the motor to determine the physical state.

60. The method of claim 56, wherein at least one of the one or more functions computes a full or partial signed distance field (SDF) representation of the complex geometry to be printed directly.

61. The method of claim 56, wherein at least one of the one or more functions creates one or more of lattices, microstructures and metamaterials

62. The method of claim 56, further comprising creating additional functions, wherein the whole or a slice of the part is evaluated with at least the one or more additional functions.

63. A three-dimensional (3D) printing system configured to print a part having complex geometry, the 3D printing system comprising:
a resin container;
a motor operatively coupled to a linear actuator for moving a build plate above the resin container;
one or more projectors situated below, and directed towards, the resin container, at least a first projector of the one or more projectors being moveable along a first linear rail; and
a processor coupled to the motor and configured to:
retrieve a physical state of the motor, the physical state including one or more of rotation, torque, voltage, and position of the build plate as controlled by the motor and forming part of a hardware state of the 3D printing system;
retrieve one or more geometric primitives, the one or more geometric primitives being respective mathematical representations of respective elements of the part with complex geometry;
input the hardware state and the one or more geometric primitives into one or more functions to evaluate a 3D geometry to be printed of a slice of the part; and
control the first projector to project light to cure a respective portion of resin in the resin container to print the 3D geometry of the slice of the part.

64. The 3D printing system of claim 63, wherein the first projector is controlled to generate an image to cure a first portion of the slice of the part, wherein:
the hardware state is updated as the first projector is moved along the first linear rail;
the 3D geometry is re-evaluated based on the updated hardware state; and
the first projector is controlled to generate another image to separately cure another portion of the slice of the part.

65. The 3D printing system of claim 63, wherein the first projector is controlled to generate an image to cure a first portion of the slice of the part, and a second projector of the one or more projectors is controlled to generate another image to separately cure another portion of the slice of the part.

66. The 3D printing system of claim 63, where resolution of the 3D geometry of the slice is based on resolution of movement of at least the first projector along the first linear rail.

67. The 3D printing system of claim 63, where at least the first projector is moveable along two perpendicular rails.

68. The 3D printing system of claim 67, where at least the first projector is moveable in a sinusoidal motion.
